(19) United States
(12) Patent Application Publication
(10) Pub. No.: US 2012/0111764 A1
(43) Pub. Date: May 10, 2012

(54) FOLDING DISPLAY APPARATUS

(75) Inventors: Robert W. LACKEY, Hickory, NC (US); Roy V. NICHOLSON, Blowing, NC (US)

(73) Assignee: PROTECT PLUS AIR, LLC, Hickory, NC (US)

(21) Appl. No.: 12/943,076

(22) Filed: Nov. 10, 2010

(51) Int. Cl. B65D 5/52; B31B 17/00

(52) U.S. Cl. 206/736; 493/84

(57) ABSTRACT

The present invention provides methods and systems for a folding display apparatus, and more particularly relates to a folding display apparatus that has a first base and a second base in a spaced apart relationship. The first base and second base include a bottom side panel, a left side panel, a right side panel, a back side panel, a right tab, and a left tab. The right tab and the left tab are selectively secured to the back side panel with tab fasteners. When constructed, the left side panel, right side panel, and back side panel of the first and second base of the folding display apparatus form a cavity therein for receiving panel filters for display on a shelf in a selectively secured arrangement.

### FIELD OF THE INVENTION

The present invention relates generally to a folding display apparatus, and more particularly relates to a folding display apparatus that has two spaced apart bases containing a bottom side panel, a left side panel, a right side panel, and a back side panel forming a cavity therein for receiving panel filters for display on a shelf in a selectively secured arrangement.

### BACKGROUND OF THE INVENTION

Display apparatus are employed everyday in order to display merchandise to a potential customer. Panel filters are typically displayed in boxes that are usually placed on the ground or stacked on a shelf. The boxes make it difficult for the customer to retrieve a panel filter from the box, because the panel filters are tightly packed within the box. In this arrangement, it is difficult for the customer to retrieve the panel filters because it is burdensome to insert a finger in between the box and panel filter. Additionally, the box is not secured to the shelf, thus increasing the amount of difficulty in retrieving a panel filter from the box. Therefore, there is a need for a display apparatus that may be secured to a structure and that allows for a customer to easily access the panel filters.

### BRIEF SUMMARY OF THE INVENTION

According to a preferred embodiment of the invention, a folding display apparatus that includes a first base and a second base, wherein the first base includes a bottom side panel, a left side panel, a right side panel, a back side panel, a left tab, and a right tab. The second base includes a bottom side panel, a left side panel, a right side panel, a back portion panel, a left tab, and a right tab. The bottom side panel of the first base is for the bottom side, the left side panel of the first base is hinged via a fold line to the bottom side panel of the first base, the right side panel of the first base is hinged via a fold line to the bottom side panel of the first base, the back side panel of the first base is hinged via a fold line to the bottom side panel of the first base, the left tab is hinged via a fold line to the left side panel of the first base, and the right tab is hinged via a fold line to the right side panel of the first base. The bottom side panel of the second base is for the bottom side, the left side panel of the second base is hinged via a fold line to the bottom side panel of the second base, the right side panel of the second base is hinged via a fold line to the bottom side panel of the second base, the back side panel of the second base is hinged via a fold line to the bottom side panel of the second base, the left tab is hinged via a fold line to the left side panel of the second base, and the right tab is hinged via a fold line to the right side panel of the second base.

According to another embodiment of the present invention, the folding display apparatus includes a retention slot is disposed on the bottom side panel of the first base for receiving a shelf fastener for selectively securing the bottom side panel of the first base to a shelf.

According to yet another embodiment of the present invention, the folding display apparatus includes at least two retention slots disposed on the bottom side panel of the first base for receiving a shelf fastener for selectively securing the bottom side panel of the first base to the shelf.

According to yet another embodiment of the present invention, a folding display apparatus includes a retention slot disposed on the bottom side panel of the second base for receiving a shelf fastener for selectively securing the bottom side panel of the second base to the shelf.

According to yet another embodiment of the present invention, a folding display apparatus includes at least two retention slots disposed on the bottom side panel of the second base for receiving a shelf fastener for selectively securing the bottom side panel of the second base to the shelf.

According to yet another embodiment of the present invention, a folding display apparatus includes a back side panel of the first base and the second base that includes a plurality of tab bores for receiving a tab fastener.

According to yet another embodiment of the present invention, a folding display apparatus includes a first height extension panel and a second height extension panel, wherein the first height extension panel is engaged to the back side panel and the right side panel of the first base and the second height extension panel is engaged to the back side panel and the right side panel of the second base.

According to yet another embodiment of the present invention, a folding display apparatus includes a display panel for engagement to the bottom side panel of the first base.

According to yet another embodiment of the present invention, a method of constructing a display apparatus that includes providing a first base, a second base, and at least four tab fasteners, wherein the first base includes a bottom side panel, a left side panel, a right side panel, a back side panel, a left tab, and a right tab. The second base includes a bottom side panel, a left side panel, a right side panel, a back side panel, a left tab, and a right tab. The bottom side panel of the first base is for the bottom side, the left side panel of the first base comprises at least one tab bore and is hinged via a fold line to the bottom side panel of the first base, the right side panel of the first base comprises at least one tab bore and is hinged via a fold line to the bottom side panel of the first base, the back side panel of the first base comprises at least one tab bore and is hinged via a fold line to the bottom side panel of the first base, the left tab is hinged via a fold line to the left side panel of the first base and comprises at least one tab bore, and the right tab is hinged via a fold line to the right side panel of the first base and comprises at least one tab bore. The bottom side panel of the second base is for the bottom side, the left side panel of the second base comprises at least one tab bore and is hinged via a fold line to the bottom side panel of the second base, the right side panel of the second base comprises at least one tab bore and is hinged via a fold line to the bottom side panel of the second base, the back side panel of the second base comprises at least one tab bore and is hinged via a fold line to the bottom side panel of the second base, the left tab is hinged via a fold line to the left side panel of the second base and comprises at least one tab bore, and the right tab is hinged via a fold line to the right side panel of the second base and comprises at least one tab bore. The back side panel, left side panel, and right side panel of the first base are folded to an upright position along the fold line. The left tab and right tab of the first base are folded along the fold line such that the left tab and right tab are positioned behind the back side panel of the first base and the at least one tab bore of the left tab and back side panel are aligned. A tab fastener is inserted through the tab bores for selectively securing the left tab to the back side panel. The at least one tab bore of the right side and back side panel are aligned and a tab fastener is inserted through the tab bores for selectively securing the right tab to the back side panel. The back side panel, left side panel, and right side panel of the second base are folded to an upright position along the fold line. The left tab and right tab of the second base are followed along the fold line such that the left tab and right tab are positioned behind the back side panel of the second base. The at least one tab bore of the left tab and back side panel are aligned and a fastener is inserted through the tab bores for selectively securing the left tab to the back side panel. The at least one tab bore of the right side panel and back side panel are aligned and a fastener is inserted through the tab bores for selectively securing the right tab to the back side panel.

According to yet another embodiment of the present invention, a method of constructing a display apparatus includes a display panel having a display front, a left side panel, and a bottom side panel, wherein the left side panel is hinged via a fold line to the display front and the bottom side panel is hinged via a fold line to the display front. The bottom side panel of the display panel is inserted under the bottom side panel of the first base.

According to yet another embodiment of the present invention, a method of constructing a display apparatus that includes providing a first height extension panel containing at least two spaced apart extension bores and at least two extension fasteners. The spaced apart extension bore is aligned with a corresponding extension bore on the back side panel of the first base. A spaced apart extension bore is aligned with the right side of the first base and the at least two extension fasteners are inserted into the spaced apart bores.

According to yet another embodiment of the present invention, a method of constructing a display apparatus that includes providing a second height extension panel containing at least two spaced apart extension bores and at least two extension fasteners. The spaced apart extension bore is aligned with a corresponding extension bore on the back side panel of the second base. The spaced apart extension bore is aligned with the right side of the second base and the at least two extension fasteners are inserted into the spaced apart extension bores.

According to yet another embodiment of the present invention, a method of constructing a display apparatus that includes providing at least two retention slots on the bottom side panel of the first base, at least two shelf fasteners, and a shelf with a plurality of spaced apart shelf bores. The shelf bores are aligned with the at least two retention slots on the bottom side and the at least two shelf fasteners are inserted through the retention slot and the shelf bores for selectively securing the bottom side panel to the shelf

According to yet another embodiment of the present invention, a method of constructing a display apparatus that includes providing at least two retention slots on the bottom side panel of the second base, at least two shelf fasteners, and a shelf with a plurality of spaced apart shelf bores. The spaced apart shelf bores of the shelf are aligned with the at least two retention slots on the bottom side and the at least two shelf fasteners are inserted through the retention slots and the shelf bores for selectively securing the bottom side to the shelf.

According to yet another embodiment of the present invention, a kit for a display apparatus includes side panel, a right side panel, a back side panel, a left tab, and a right tab and the second base includes a bottom side panel, a left side panel, a right side panel, a back portion panel, a left tab, and a right tab. The bottom side panel of the first base is for the bottom side, the left side panel of the first base is hinged via a fold line to the bottom side panel of the first base, the right side panel of the first base is hinged via a fold line to the bottom side panel of the first base, the back side panel of the first base is hinged via a fold line to the bottom side panel of the first base, the left tab is hinged via a fold line to the left side panel of the first base, and the right tab is hinged via a fold line to the right side panel of the first base. The bottom side panel of the second base is for the bottom side panel, the left side panel of the second base is hinged via a fold line to the bottom side panel of the second base, the right side panel of the second base is hinged via a fold line to the bottom side panel of the second base, the back side panel of the second base is hinged via a fold line to the bottom side panel of the second base, the left tab is hinged via a fold line to the left side panel of the second base, and the right tab is hinged via a fold line to the right side panel of the second base.

According to yet another embodiment of the present invention, the kit for a display apparatus includes a first height extension panel, wherein the first height extension panel is engaged to the back side panel and the right side panel of the first base.

According to yet another embodiment of the present invention, the kit for a display apparatus includes a second height extension panel, wherein the second height extension panel is engaged to the back side panel and the right side panel of the first base.

According to yet another embodiment of the present invention, the kit for a display apparatus includes a display panel for engaging to the bottom side panel of the first base.

According to yet another embodiment of the present invention, the kit for a display apparatus includes a retention slot disposed on the bottom side panel of the first base for receiving a shelf fastener for selectively securing the bottom side panel of the first base to a shelf.

According to yet another embodiment of the present invention, the kit for a display apparatus includes at least two retention slots disposed on the bottom side panel of the first base for receiving a shelf fastener for selectively securing the bottom side panel of the first base to a shelf.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the first base;

FIG. 2 is a perspective view of the second base;

FIG. 3 is another perspective view of the first base;

FIG. 4 is a perspective view of the first base in a partially assembled state;

FIG. 5 is a perspective view of the first base in an assembled state;

FIG. 6 is perspective view of the first base and the engagement of the first height extension panel and display panel;

FIG. 7 is another perspective view of the second base;

FIG. 8 is a perspective view of the second base in a partially assembled state;

FIG. 9 is a perspective view of the second base in an assembled state;

FIG. 10 is a perspective view of the second base engaged to a shelf;

FIG. 11 is a perspective view of the second height extension panel inserted onto the second base;

FIG. 12 is a perspective view of an exemplary tab fastener;

FIG. 13 is a perspective view of an exemplary shelf fastener;

FIG. 14 is a perspective view of the assembly with the first base and second base selectively secured to a shelf with the first height extension panel and second height extension panel;

FIG. 15 a perspective view of the assembly with the first base and second base selectively secured to a shelf with the first height extension panel and second height extension panel, including the insertion of panel filters; and

FIG. 16 is a perspective view of the assembly with the first base and second base selectively secured to a shelf with the first height extension panel and second height extension panel, including the panel filters inserted therebetween.

### DETAILED DESCRIPTION OF THE INVENTION

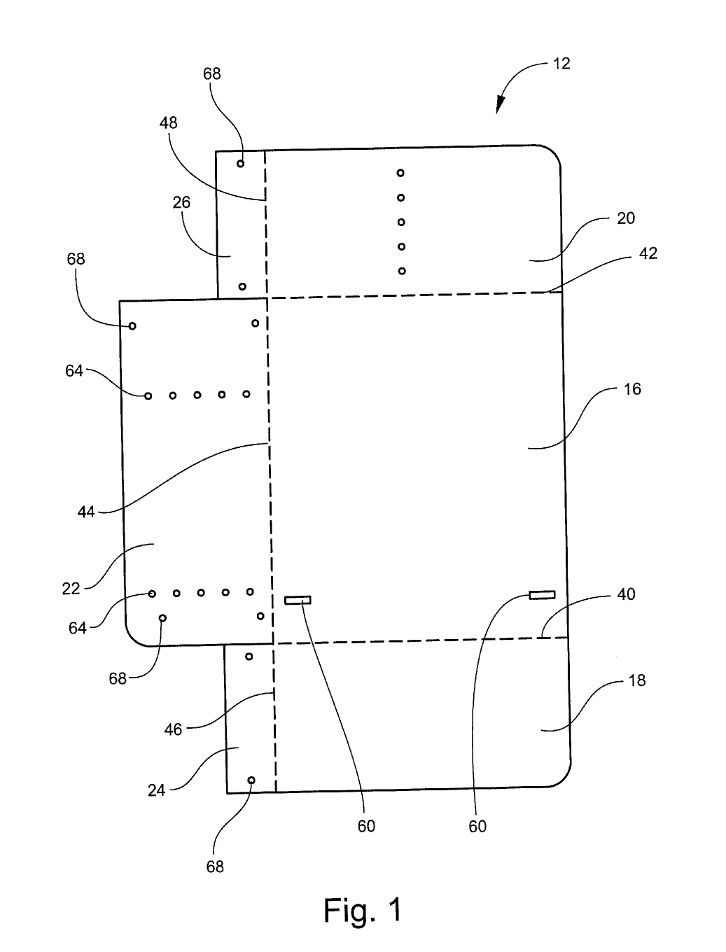

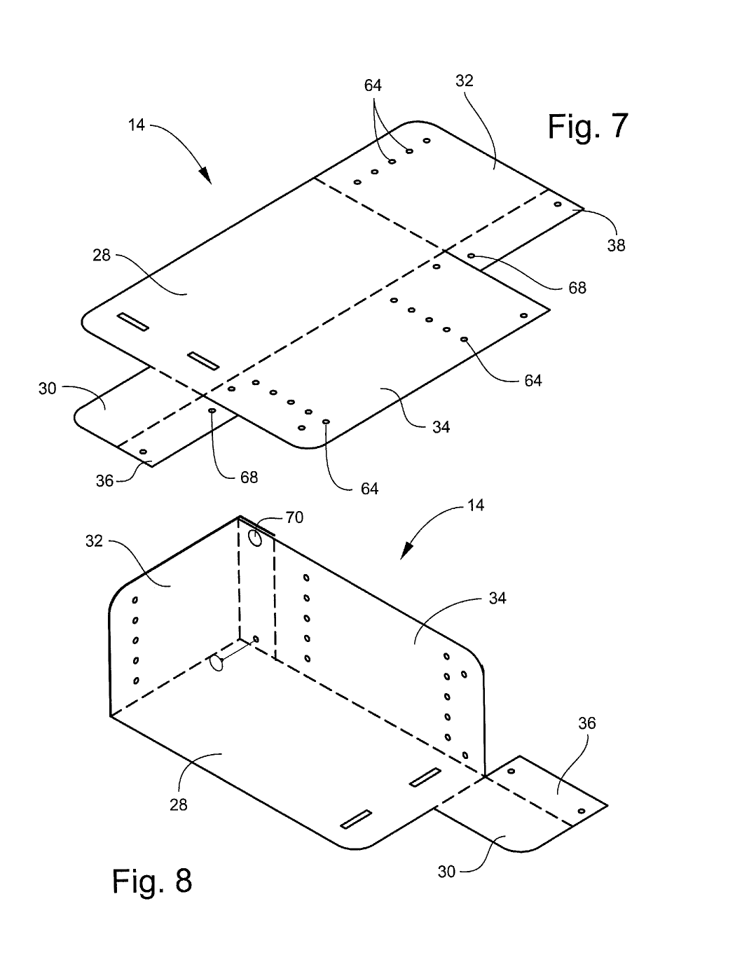

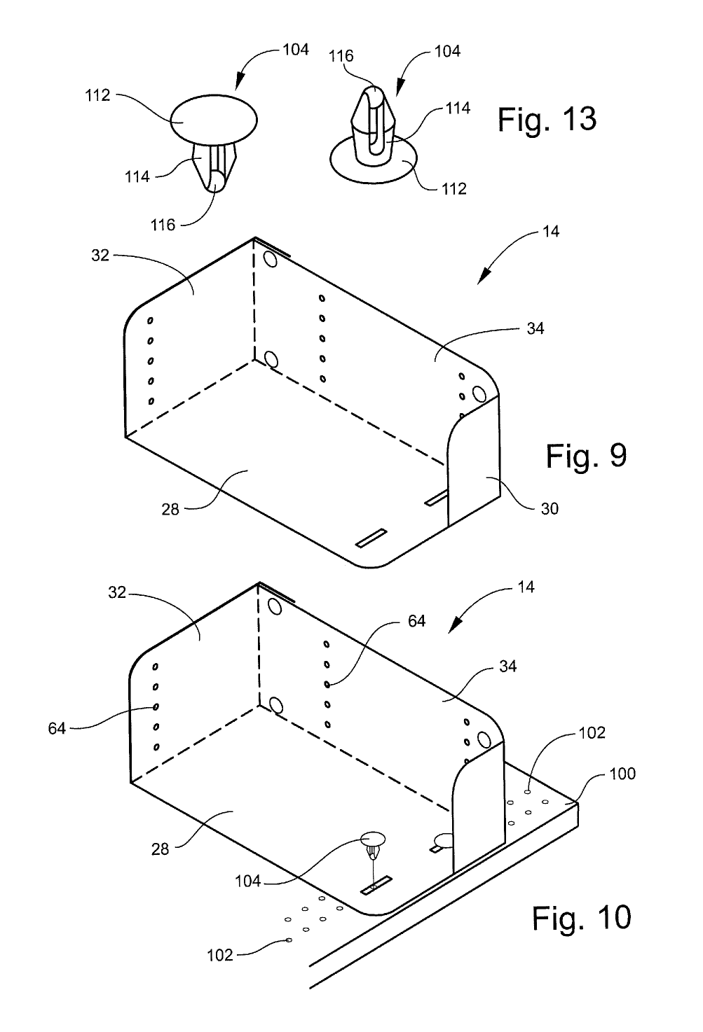

Referring now specifically to the drawings, an exemplary folding display apparatus is illustrated in the figures and is shown generally at reference numeral 10. As illustrated in FIGS. 1 through 11, the apparatus 10 has a first base 12 and a second base 14. The first base 12 comprises a bottom side panel 16, a left side panel 18, a right side panel 20, a back side panel 22, a left tab 24, and a right tab 26. The second base 14 comprises a bottom side panel 28, a left side panel 30, a right side panel 32, a back side panel 34, a left tab 36, and a right tab 38.

The bottom side panel 16 of the first base 12 is for the bottom side, the left side panel 18 of the first base 12 is hinged via a fold line 40 to the bottom side panel 16 of the first base 12, the right side panel 20 of the first base 12 is hinged via a fold line 42 to the bottom side panel 16 of the first base 12, the back side panel 22 of the first base 12 is hinged via a fold line 44 to the bottom side panel 16 of the first base 12, the left tab 24 is hinged via a fold line 46 to the left side panel 18 of the first base 12, and the right tab 26 is hinged via a fold line 48 to the right side panel 20 of the first base 12.

The bottom side panel 28 of the second base 14 is for the bottom side, the left side panel 30 of the second base 14 is hinged via a fold line 50 to the bottom side panel 28 of the second base 14, the right side panel 32 of the second base 14 is hinged via a fold line 52 to the bottom side panel 28 of the second base 14, the back side panel 34 of the second base 14 is hinged via a fold line 54 to the bottom side panel 28 of the second base 14, the left tab 36 is hinged via a fold line 56 to the left side of the second base 14, and the right tab 38 is hinged via a fold line 58 to the right side panel 32 of the second base 14.

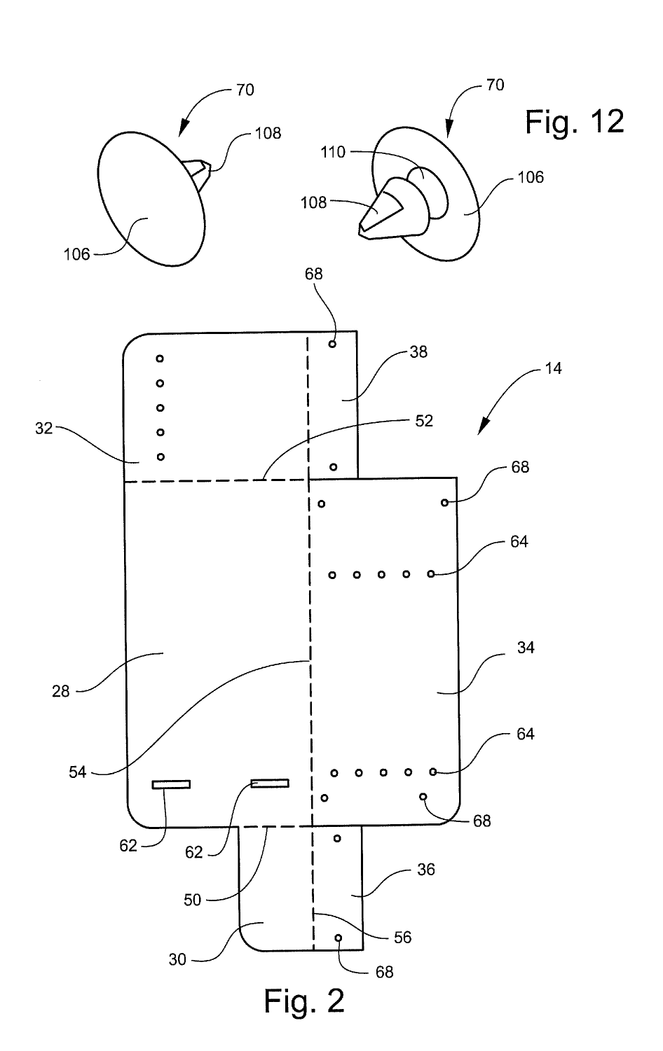

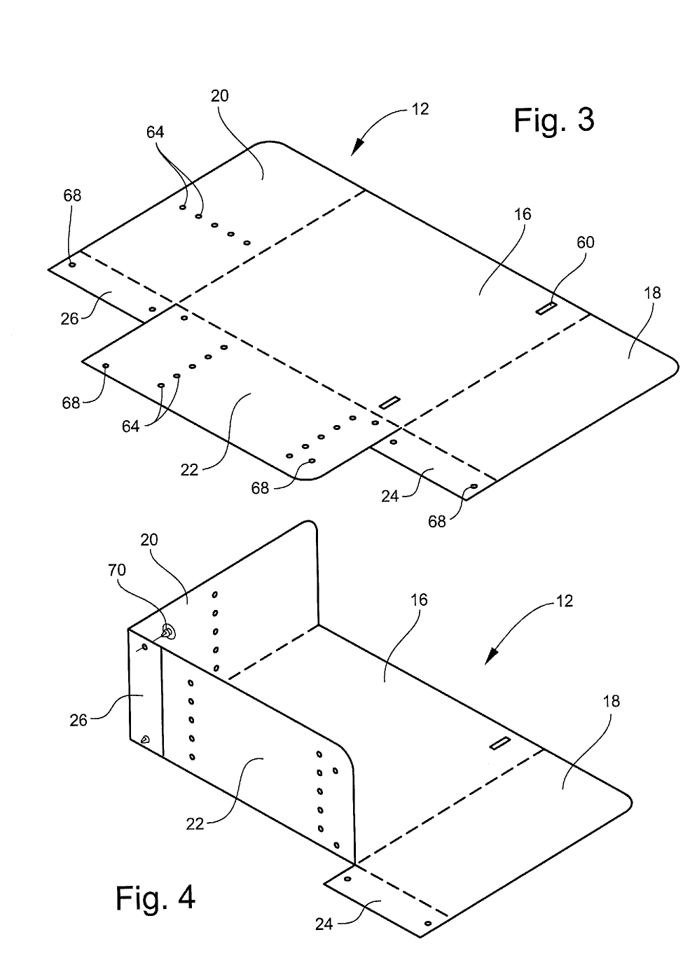

The bottom side 16 of the first base 12 comprises two spaced apart retention slots 60. As shown in FIGS. 1 and 3, the retention slots 60 are positioned towards the left side of the bottom side 16. In other words, the retention slots 60 are positioned on the opposite side of the bottom side 16 than where the right side panel 20 is located. The bottom side 28 of the second base 14 comprises two spaced apart retention slots 62. As shown in FIGS. 2, 7, and 8, the retention slots 62 are positioned towards the left side of the bottom side 28. In other words, the retention slots 62 are positioned on the opposite side of the bottom side 28 than where the right side panel 20 is located.

The back side panel 22 of the first base 12 includes two columns of spaced apart bores 64. As illustrated in FIG. 1, the back side panel 22 includes two columns of five spaced apart bores 64. One of ordinary skill in the art would understand that any number of bores 64 may be disposed on the back side panel 22, including a single bore 64 disposed on either side of the back side panel 22. The back side panel 22 of the first base 12 also includes a pair of tab bores 68 on either end of the back side panel 22. In other words, a pair of tab bores 68 is located on the side of the back side panel 22 adjacent the right tab 26 and a pair of tab bores 68 is located on the side of the back side panel 22 adjacent the left tab 24. It would be understood by one of ordinary skill in the art that any number of tab bores 68 may disposed on the back side panel 22, including a single tab bore 68 disposed on either side of the back panel 22.

The left tab 24 of the first base 12 includes two spaced apart tab bores 68. The tab bores 68 of the left tab 24 are positioned such that when the left tab 24 is positioned behind the back side panel 22, the tab bores 68 of the back side panel 22 and tab bores 68 of the left tab 24 may be aligned with one another for receiving a tab fastener 70. The tab fastener 70 is designed to releasably secure the left tab 24 to the back side panel 22. The right tab 26 of the second base 14 includes two spaced apart tab bores 68. The tab bores 68 of the right tab 26 are positioned such that when the right tab 26 is positioned behind the back side panel 22, the tab bores 68 of the back side panel 22 and tab bores 68 of the right tab 26 may be aligned with one another for receiving a tab fastener 70. The tab fastener 70 is designed to releasably secure the right tab 26 to the back side panel 22.

The right side panel 20 of the first base 12 includes a column of spaced apart extension bores 64. As illustrated in FIG. 1, the right side panel 20 includes a column of five spaced apart extension bores.

The back side panel 34 of the second base 14 includes two columns of spaced apart extension bores 64. As illustrated in FIG. 2, the back side panel 34 includes two columns of five spaced apart extension bores 64. One of ordinary skill in the art would understand that any number of extension bores 64 may be disposed on the back side panel 34, including a single extension bore 64 disposed on either side of the back side panel 34. The back side panel 34 of the second base 14 also includes a pair of tab bores 68 on either end of the back side panel 34. In other words, a pair of tab bores 68 is located on the side of the back side panel 34 adjacent the right tab 38 and a pair of tab bores 68 are located on the side of the back side panel 34 adjacent the left tab 36. It should be understood by one of ordinary skill in the art that any number of tab bores 68 may disposed on the back side panel 34, including a single tab bore 68 disposed on either side of the back panel 34.

The left tab 36 of the second base 14 includes two spaced apart tab bores 68. The tab bores 68 of the left tab 36 are positioned such that when the left tab 36 is positioned behind the back side panel 34, the tab bores 68 of the back side panel 34 and tab bores 68 of the left tab 36 may be aligned with one another for receiving a tab fastener 70. The tab fastener 70 is designed to releasably secure the left tab 36 to the back side panel 34. The right tab 38 of the second base 14 includes two spaced apart tab bores 68. The tab bores 68 of the right tab 38 are positioned such that when the right tab 38 is positioned behind the back side panel 34, the tab bores 68 of the back side panel 34 and tab bores 68 of the right tab 38 may be aligned with one another for receiving a tab fastener 70. The tab fastener 70 is designed to releasably secure the right tab 38 to the back side panel 34.

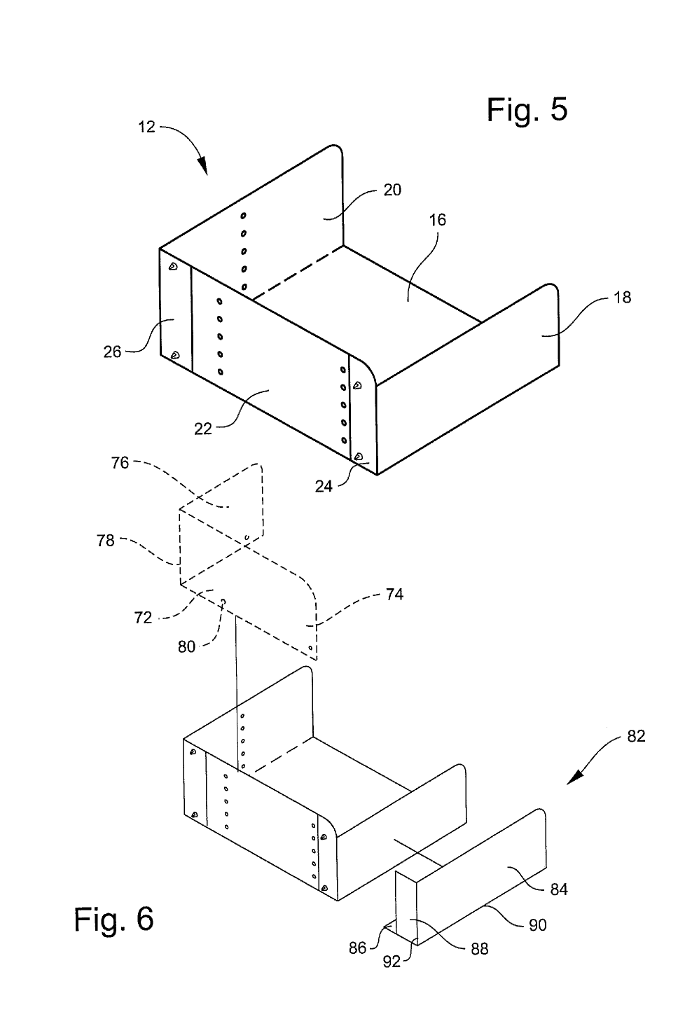

The apparatus 10 also includes an optional first height extension panel 72, as illustrated in FIG. 6. The first height extension panel 72 has a first side 74 and a second side 76. The first height extension panel 72 includes a fold line 78 that allows the first side 74 to bend about 90 degrees relative to the second side 76. Three extension panel bores 80 are disposed on the first height extension panel 72. As illustrated in FIG. 5, two extension panel bores 80 are in a spaced apart relationship on the first side 74 and a single extension panel bore 80 is disposed on the second side 76. However, it will be known by one of ordinary skill in the art that any number of extension panel bores 80 may be disposed on the first height extension panel 72. The purpose of the first height extension panel 72 is to increase the height of the right side panel 20 and back side panel 22 for accommodating more panel filters 118. In operation and as illustrated in FIG. 6, the first side 74 of the first height extension panel 72 is engaged to the back side panel 22 of the first base 12. The extension panel bores 80 and the extension bores 64 are aligned for receiving a tab fastener 70 therethrough. The second side 76 of the first height extension panel 72 is engaged to the right side panel 20 of the first base 12. The extension panel bore 80 and the extension bore 64 are aligned for receiving a tab fastener 70 therethrough.

The apparatus 10 may also include a display panel 82, as shown in FIG. 6. The display panel 82 includes a display face 82, a bottom side panel 86, and a left side panel 88. The display panel 82 is designed to have some indicia affixed, printed, or engaged to the face 84 of the display panel 82. The indicia may be an advertisement, instructions, or the like. The display face 82 is for the display face 82. The bottom side panel 86 is hinged via a fold line 90 to the display face 82. The left side panel 88 is hinged via a fold line 92 to the display face 84. During use, the left side panel 88 is folded along the fold line 92 to an angle of about 90 degrees with respect to the display face 84. The bottom side panel 86 is folded along the fold line 90 to an angle of about 90 degrees with respect to the display face 84. The bottom side panel 86 is inserted under the bottom side panel 16 of the first base 12 and is retained by friction fit. In addition to friction fit, the display panel 82 may be engaged to the first base 12 with an adhesive or through the use of a fastener. The left side panel 88 of the display panel 82 is positioned adjacent the back side panel 22 of the first base 12.

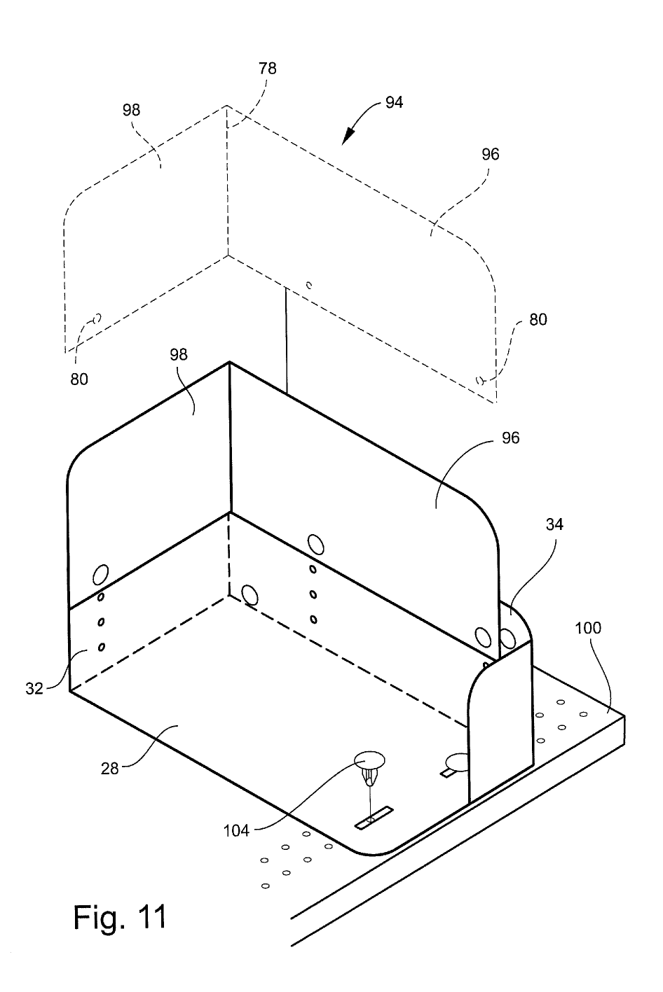

The apparatus 10 also includes an optional second height extension panel, as illustrated in FIG. 11. The second height extension panel 94 has a first side 96 and a second side 98. The second height extension panel 94 includes a fold line 78 that allows the first side 96 to bend about 90 degrees relative to the second side 98. Three extension panel bores 80 are disposed on the second height extension panel 94. As illustrated in FIG. 11, two extension panel bores 80 are in a spaced apart relationship on the first side 96 and a single extension panel bore 80 is disposed on the second side 98. However, it will be known by one of ordinary skill in the art that any number of extension panel bores 80 may be disposed on the second height extension panel 94. The purpose of the second height extension panel 94 is to increase the height of the right side panel 32 and back side panel 34 for accommodating more panel filters. In operation and as illustrated in FIG. 11, the first side 96 of the second height extension panel 94 is engaged to the back side panel 34 of the second base 14. The extension panel bores 80 and the extension bores 64 are aligned for receiving a tab fastener 70 therethrough. The second side 98 of the second height extension panel 94 is engaged to the right side panel 32 of the second base 14. The extension panel bore 80 and the extension bore 64 are aligned for receiving a tab fastener 70 therethrough.

As illustrated in FIGS. 10, 11, and 14, the apparatus 10 is intended to be selectively secured to a shelf 100 having spaced apart shelf bores 102. The shelf bores 102 are positioned on the shelf, such as in Gondola shelving. The retention slots (60, 62) of the first base 12 and second base 14 are aligned over a similarly situated shelf bore 102. In other words, the retention slot 60 is aligned over top of a shelf bore 102 and the retention slot 62 is aligned over top of a shelf bore 102. Once the retention slots 60 and 62 are aligned over the shelf bore 102, a shelf fastener 104 is inserted through the retention slots (60, 62) and the shelf bore 102 for selectively securing the first base 12 and second base 14 to the shelf 100.

An exemplary embodiment of the tab fastener 70 is illustrated in FIG. 12. The tab fastener 70 preferably has a head 106 and a body 108 that are connected by a neck 110. The body 108 has a diameter greater than that of the neck 110 of the tab fastener 70. The body 108 is designed to be inserted through the respective tab bore and tab bores (64, 68), whereby the head 106 is positioned on one side of the tab bore or tab bores (64, 68) and the body 108 is positioned on the opposite side of the tab bore or tab bores (64, 68). It should be known that any such fastener that would selectively secure the right tab to the back side panel and the left tab to the back side panel together may be utilized.

An exemplary embodiment of the shelf fastener 104 is illustrated in FIG. 13. The shelf fastener 104 comprises a head 112 and three resilient fingers 114 extending therefrom that are spaced apart by a retention ball 116. The three resilient fingers 114 are inserted through the retention slots (60, 62) and through the shelf bore 102. The head is adjacent the bottom side panel (16, 28) and the resilient fingers 114 and retention ball 116 extending through the retention slots (60, 62) and the shelf bore 102. It should be known that any such fastener that would selectively secure the first base 12 and second base 14 to a shelf 100 may be utilized.

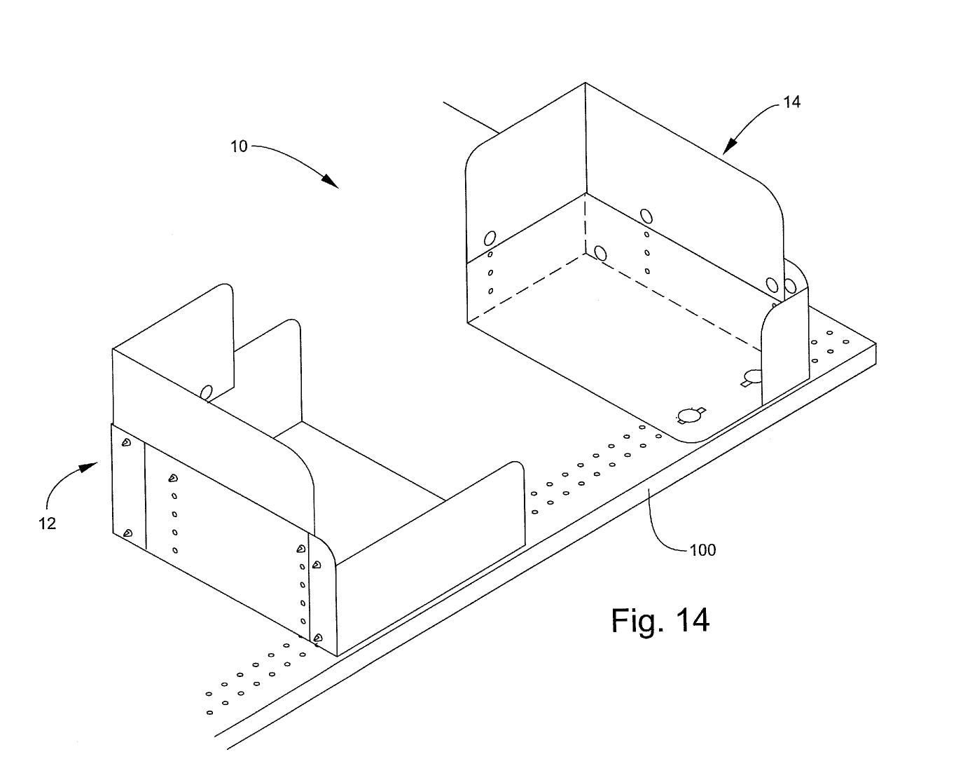

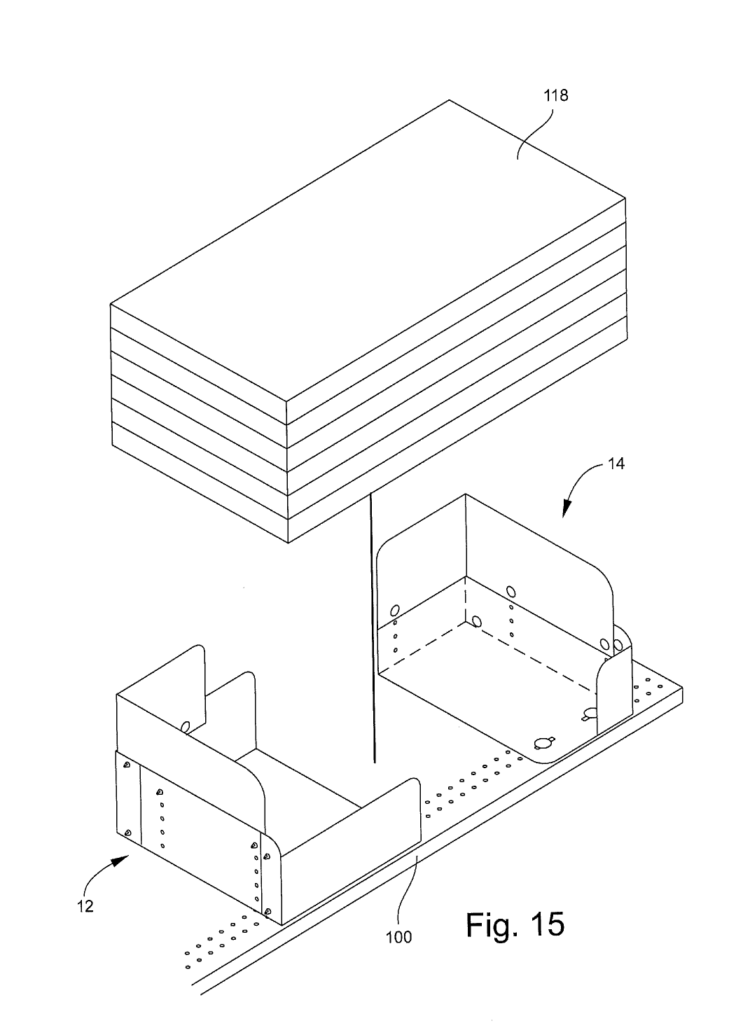

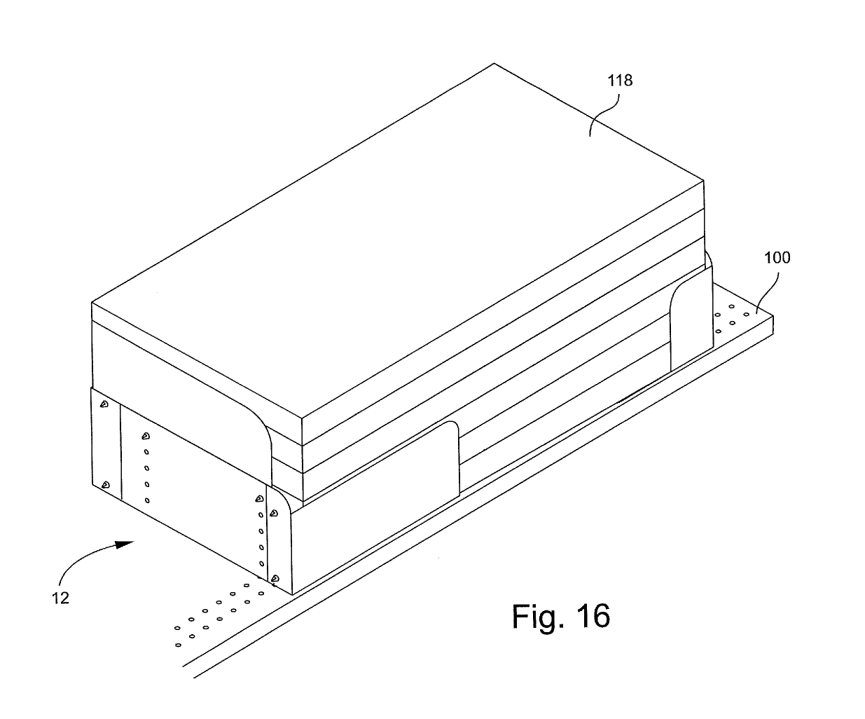

During use and as illustrated in FIGS. 14, 15 and 16, the first base 12 and second base 14 are designed to be selectively secured to a shelf 100 in a spaced apart arrangement. The distance between the first base 12 and second base 14 may vary depending upon the dimensions of the panel filter 118 designed to be displayed within the apparatus 10. The panel filters 118 are intended to be placed within the first base 12 and second base 14. Preferably, six panel filters 118 may be displayed in this arrangement. The first height extension panel 72 and second height extension panel 94 may be engaged to the first base 12 and second base 14 respectively for storing more panel filters 118, preferably up to 20 panel filters 118.

During use, the left side panel 18 of the first base 12 is folded via the fold line and the right side panel 20 of the first base 12 is folded via the fold line 42. The back side panel 22 of the first base 12 is folded via the fold line 44, the left tab 24 is folded via the fold line 46, and the right tab 26 is folded via the fold line 48. The tab bores 68 of the right tab 26 and left tab 24 are aligned with the tab bore 68 of the back side panel 22, as shown in FIGS. 4 and 5. A tab fastener 70 is inserted within the tab bore 68 forming a selectively secured arrangement.

The left side panel 30 of the second base 14 is folded via the fold line 50 to the bottom side panel 28 of the second base 14, the right side panel 32 of the second base 14 is folded via the fold line 52. The back side panel 34 of the second base 14 is folded via the fold line 54 to the bottom side panel 28, the left tab 36 is folded via the fold line 56, and the right tab 38 is folded via the fold line 58. The tab bores 68 of the right tab 38 and left tab 36 are aligned with the tab bore 68 of the back side panel 34, as shown in FIGS. 8, 9, and 10. A tab fastener 70 is inserted within the tab bore 68 forming a selectively secured arrangement.

The present invention may be packaged as a kit for assembly and display. The kit of the display apparatus includes a first base 12 and a second base 14. The first base 12 comprises a bottom side panel 16, a left side panel 18, a right side panel 20, a back side panel 22, a left tab 24, and a right tab 26. The second base 14 comprises a bottom side panel 28, a left side panel 30, a right side panel 32, a back side panel 34, a left tab 36, and a right tab 38.

Optionally, the kit may include a first height extension panel 72, a second height extension panel 94, and a display panel 82. Additionally, up to four shelf fasteners 104 may be included in the kit and up to fourteen tab fasteners 70 may be included in the kit.

The terms bottom, left, right, and back may change depending upon a relative position (e.g. in some situations the right may be the left and vice versa), for purposes of orientation and to provide the detailed description herein (without necessary limiting the claims), it is understood that the relative orientation and positions will be described as illustrated in the drawings, particularly FIGS. 1 and 2.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A folding display apparatus, comprising:
A first base and a second base, wherein the first base includes a bottom side panel, a left side panel, a right side panel, a back side panel, a left tab, and a right tab and the second base includes a bottom side panel, a left side panel, a right side panel, a back portion panel, a left tab, and a right tab;
the bottom side panel of the first base is for the bottom side, the left side panel of the first base is hinged via a fold line to the bottom side panel of the first base, the right side panel of the first base is hinged via a fold line to the bottom side panel of the first base, the back side panel of the first base is hinged via a fold line to the bottom side panel of the first base, the left tab is hinged via a fold line to the left side panel of the first base, and the right tab is hinged via a fold line to the right side panel of the first base; and
the bottom side panel of the second base is for the bottom side panel, the left side panel of the second base is hinged via a fold line to the bottom side panel of the second base, the right side panel of the second base is hinged via a fold line to the bottom side panel of the second base, the back side panel of the second base is hinged via a fold line to the bottom side panel of the second base, the left tab is hinged via a fold line to the left side panel of the second base, and the right tab is hinged via a fold line to the right side panel of the second base.

2. The folding display apparatus according to claim 1, further comprising a retention slot disposed on the bottom side panel of the first base for receiving a shelf fastener for selectively securing the bottom side panel of the first base to a shelf.

3. The folding display apparatus according to claim 1, further comprising at least two retention slots disposed on the bottom side panel of the first base for receiving a shelf fastener for selectively securing the bottom side panel of the first base to a shelf.

4. The folding display apparatus according to claim 1, further comprising a retention slot disposed on the bottom side panel of the second base for receiving a shelf fastener for selectively securing the bottom side panel of the second base to a shelf.

5. The folding display apparatus according to claim 1, further comprising at least two retention slots disposed on the bottom side panel of the second base for receiving a shelf fastener for selectively securing the bottom side panel of the second base to a shelf.

6. The folding display apparatus according to claim 1, wherein the back side panel of the first base and the second base comprises a plurality of tab bores for receiving a tab fastener.

7. The folding display apparatus according to claim 1, further comprising a first height extension panel and a second height extension panel, wherein the first height extension panel is engaged to the back side panel and the right side panel of the first base and the second height extension panel is engaged to the back side panel and the right side panel of the second base.

8. The folding display apparatus according to claim 1, further comprising a display panel for engagement to the bottom side panel of the first base.

9. A method of constructing a display apparatus, comprising:
providing a first base, a second base, and at least four tab fasteners, wherein the first base includes a bottom side panel, a left side panel, a right side panel, a back side panel, a left tab, and a right tab and the second base includes a bottom side panel, a left side panel, a right side panel, a back side panel, a left tab, and a right tab; the bottom side panel of the first base is for the bottom side, the left side panel of the first base comprises at least one bore and is hinged via a fold line to the bottom side panel of the first base, the right side panel of the first base comprises at least one tab bore and is hinged via a fold line to the bottom side panel of the first base, the back side panel of the first base comprises at least one tab bore and is hinged via a fold line to the bottom side panel of the first base, the left tab is hinged via a fold line to the left side panel of the first base and comprises at least one bore, and the right tab is hinged via a fold line to the right side panel of the first base and comprises at least one bore; and the bottom side panel of the second base is for the bottom side, the left side panel of the second base comprises at least one tab bore and is hinged via a fold line to the bottom side panel of the second base, the right side panel of the second base comprises at least one tab bore and is hinged via a fold line to the bottom side panel of the second base, the back side panel of the second base comprises at least one tab bore and is hinged via a fold line to the bottom side panel of the second base, the left tab is hinged via a fold line to the left side panel of the second base and comprises at least one tab bore, and the right tab is hinged via a fold line to the right side panel of the second base and comprises at least one tab bore; folding the back side panel, left side panel, and right side panel of the first base to an upright position along the fold line;
folding the left tab and right tab of the first base along the fold line such that the left tab and right tab are positioned behind the back side panel of the first base and the at least one tab bore of the left tab and back side panel are aligned and inserting a tab fastener therethrough for selectively securing the left tab to the back side panel and the at least one tab bore of the right side and back side panel are aligned and inserting a tab fastener therethrough for selectively securing the right tab to the back side panel;
folding the back side panel, left side panel, and right side panel of the second base to an upright position along the fold line; and
folding the left tab and right tab of the second base along the fold line such that the left tab and right tab are positioned behind the back side panel of the second base and the at least one tab bore of the left tab and back side panel are aligned and inserting a tab fastener therethrough for selectively securing the left tab to the back side panel and the at least one bore of the right side panel and back side panel are aligned and inserting a tab fastener therethrough for selectively securing the right tab to the back side panel.

10. The method of constructing a display apparatus according to claim 9, further comprising providing a display panel having a display front, a left side panel, and a bottom side panel, wherein the left side panel is hinged via a fold line to the display front and the bottom side panel is hinged via a fold line to the display front and inserting the bottom side panel under the bottom side panel of the first base.

11. The method of constructing a display apparatus according to claim 9, further comprising providing a first height extension panel containing at least two spaced apart extension bores and at least two fasteners and aligning a spaced apart extension bore with a corresponding extension bore on the back side panel of the first base and aligning a spaced apart extension bore with the right side of the first base and inserting the at least two fasteners into the spaced apart extension bores.

12. The method of constructing a display apparatus according to claim 9, further comprising providing a second height extension panel containing at least two spaced apart extension bores and at least two fasteners and aligning a spaced apart extension bore with a corresponding extension bore on the back portion of the second base and aligning a spaced apart extension bore with the right side panel of the second base and inserting the at least two extension fasteners into the spaced apart extension bores.

13. The method of constructing a display apparatus according to claim 9, further comprising providing at least two retention slots on the bottom side panel of the first base, at least two shelf fasteners, and a shelf with a plurality of spaced apart shelf bores, and aligning the spaced apart shelf bores of the shelf with the at least two retention slots on the bottom side panel and inserting the at least two shelf fasteners through the retention slot and shelf bore for selectively securing the bottom side panel to the shelf.

14. The method of constructing a display apparatus according to claim 9, further comprising providing at least two retention slots on the bottom side panel of the second base, at least two shelf fasteners, and a shelf with a plurality of spaced apart shelf bores, and aligning the spaced apart shelf bores with the at least two retention slots on the bottom side panel and inserting the at least two shelf fasteners through the retention slot and shelf bores for selectively securing the bottom side panel to the shelf.

15. A kit for a display apparatus comprising:
a first base having a bottom side panel, a left side panel, a right side panel, a back side panel, a left tab, and a right tab; and
a second base having a bottom side panel, a left side panel, a right side panel, a back side panel, a left tab, and a right tab;
whereby, the bottom side panel of the first base is for the bottom side, the left side panel of the first base is hinged via a fold line to the bottom side panel of the first base, the right side panel of the first base is hinged via a fold line to the bottom side of the first base, the back side panel of the first base is hinged via a fold line to the bottom side panel of the first base, the left tab is hinged via a fold line to the left side panel of the first base, and the right tab is hinged via a fold line to the right side panel of the first base; and the bottom side panel of the second base is for the bottom side, the left side panel of the second base is hinged via a fold line to the bottom side panel of the second base, the right side panel of the second base is hinged via a fold line to the bottom side panel of the second base, the back side panel of the second base is hinged via a fold line to the bottom side panel of the second base, the left tab is hinged via a fold line to the left side panel of the second base, and the right tab is hinged via a fold line to the right side panel of the second base.

16. The kit for a display apparatus of claim 15, further comprising a first height extension panel, wherein the first height extension panel is engaged to the back side panel and the right side panel of the first base.

17. The kit for a display apparatus of claim 15, further comprising a second height extension panel, wherein the second height extension panel is engaged to the back side panel and the right side panel of the first base.

18. The kit for a display apparatus according to claim 15, further comprising a display panel for engaging to the bottom side panel of the first base.

19. The kit for a display apparatus according to claim 15, further comprising a retention slot disposed on the bottom side panel of the first base for receiving a shelf fastener for selectively securing the bottom side panel of the first base to a shelf.

20. The kit for a display apparatus according to claim 15, further comprising at least two retention slots disposed on the bottom side panel of the first base for receiving a shelf fastener for selectively securing the bottom side panel of the first base to a shelf.
